(19) United States
(12) Patent Application Publication
(10) Pub. No.: US 2017/0043980 A1
(43) Pub. Date: Feb. 16, 2017

(54) ELEVATOR SILL

(71) Applicant: MITSUBISHI ELECTRIC CORPORATION, Chiyoda-ku (JP)

(72) Inventors: Keigo YAMAMOTO, Chiyoda-ku (JP); Takashi ISHIDA, Inazawa-shi (JP)

(73) Assignee: MITSUBISHI ELECTRIC CORPORATION, Chiyoda-ku (JP)

(21) Appl. No.: 15/307,535

(22) PCT Filed: Jun. 3, 2014
(86) PCT No.: PCT/JP14/64733

§ 371 Date: Oct. 28, 2016

(51) Int. Cl. B66B 13/30

(52) U.S. Cl. CPC B66B 13/301

(57) ABSTRACT

A sill for an elevator, wherein a first support member and a first surface member are configured as separate members, and a second support member and a second surface member are configured as separate members. One of the first and second surface members has one upper plate section forming one upper surface of the sill, a bottom plate section forming a bottom surface of a sill groove, and one side plate section forming one side surface of the sill groove. The other of the first and second surface members has another upper plate section forming another upper surface of the sill, and another side plate section forming another side surface of the sill groove. A space into which a detachment prevention member provided on a lower part of the door panel is inserted is formed between the other side plate section and the bottom plate section.

### TECHNICAL FIELD

This invention relates to a sill for an elevator which is provided in a lower part of an entrance/exit (for example, a landing entrance/exit or car entrance/exit, etc.), and in which a sill groove is formed.

### BACKGROUND ART

In the prior art, a landing door separation prevention structure for an elevator has been proposed, in which, in order to prevent detachment of a shoe provided on a lower part of a door which opens and closes an entrance/exit, from a rail groove in a sill, an engagement bracket is provided on the lower part of the door, and an engagement groove into which the front end of the engagement bracket is inserted is provided in an inside wall of the rail groove (see PTL 1 and 2).

[PTL 1] Japanese Translation of PCT Application No. 2011-520737

[PTL 2] Japanese Translation of PCT Application No. 2012-502865

### SUMMARY OF INVENTION

### Technical Problem

However, in the conventional landing door separation prevention structure for an elevator indicated in PTL 1 and 2, since the sill provided with an engagement groove in an inside wall of the rail groove is configured from a single member, then if the material of the sill is a material to which it is difficult to apply an extrusion process or drawing process, etc., the sill must be manufactured by a cutting process or bending process, etc., from a single member, and the sill is difficult to manufacture.

The present invention was devised in view of the problem described above, an object thereof being to obtain a sill for an elevator which can prevent detachment of a door, while also being easy to manufacture.

### Solution to Problem

The sill for an elevator according to this invention is a sill for an elevator, provided in a lower part of an entrance/exit which is opened and closed by movement of a door including a door panel, a sill groove being formed in the sill along a direction of movement of the door, and one upper surface and another upper surface being formed in the sill on both sides of the sill groove in a width direction thereof, wherein the sill includes: a foundation; and first and second sill members which are provided respectively on the foundation; the first sill member has a first support member fixed to the foundation and a first surface member, which is separate member from the first support member and is fixed to the first support member; the second sill member has a second support member fixed to the foundation and a second surface member, which is separate member from the second support member and is fixed to the second support member; and of the first and second surface members, one has one upper plate section forming the one upper surface, a bottom plate section forming a bottom surface of the sill groove, and one side plate section which connects the one upper plate section and the bottom plate section and forms one side surface of the sill groove; and the other has another upper plate section forming the other upper surface, and another side plate section which projects downwards from the other upper plate section and forms another side surface of the sill groove; and a space into which a detachment prevention member provided on a lower part of the door panel is inserted is formed between the other side plate section and the bottom plate section.

### Advantageous Effects of Invention

According to the sill for an elevator according to this invention, it is possible to prevent detachment of the door, by coupling a detachment prevention member in the space formed between the other side plate section and the bottom plate section. Furthermore, it is possible to simplify the respective shapes of the first and second surface members, and the manufacture of the sill can be made easier.

### BRIEF DESCRIPTION OF DRAWINGS

FIG. 1 is a front surface drawing showing a landing entrance/exit position of an elevator according to a first embodiment of this invention.

FIG. 2 is a cross-sectional diagram along line II-II in FIG. 1.

FIG. 3 is an enlarged cross-sectional diagram showing a landing sill in FIG. 2.

FIG. 4 is a principal cross-sectional diagram showing a landing door and a landing sill according to a second embodiment of this invention.

FIG. 5 is an enlarged cross-sectional diagram showing a landing sill in FIG. 4.

### DESCRIPTION OF EMBODIMENTS

A preferred embodiment of this invention is described below with reference to the drawings.

### First Embodiment

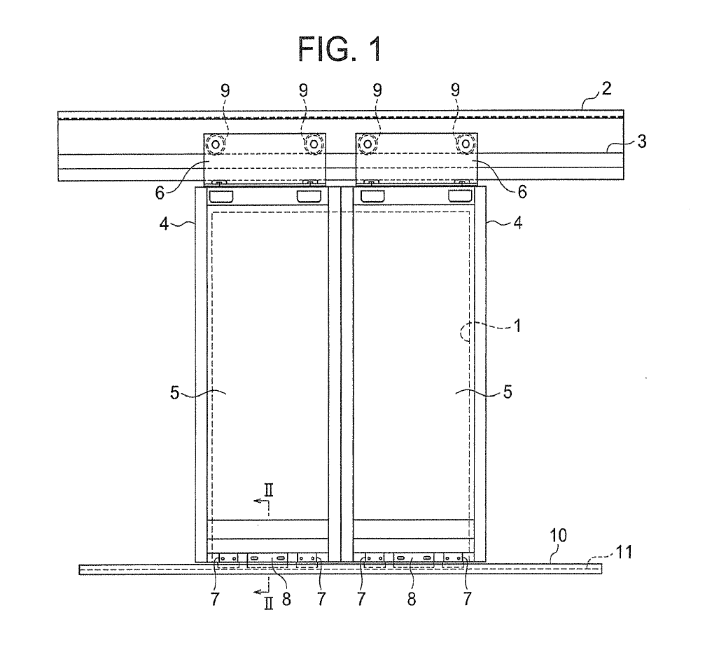

FIG. 1 is a front surface drawing showing a landing entrance/exit position of an elevator according to a first embodiment of this invention. FIG. 1 shows a landing entrance/exit device as viewed from the inside of an elevator shaft. In FIG. 1, a landing entrance/exit 1 which connects the elevator shaft with a landing is provided at the landing on each floor. A hanger case 2 fixed to the inner wall surface of the elevator shaft is disposed in the upper part of the landing entrance/exit 1. A door rail 3 which is disposed along the opening direction (width direction) of the landing entrance/exit 1 is supported on the hanger case 2. A pair of landing doors 4 are hung on the door rail 3.

The landing doors 4 are able to move in mutually opposite directions along the opening direction of the landing entrance/exit 1, while being guided by the door rail 3. The landing entrance/exit 1 is opened and closed by means of the landing doors 4 moving in mutually opposite directions.

The landing doors 4 each have a door panel 5, a door hanger 6 fixed to the upper part of the door panel 5, a pair of door guide shoes 7 which are fixed to the lower part of the door panel 5 and are disposed apart from each other in the width direction of the door panel 5, and a detachment prevention member 8 which is fixed to the lower part of the door panel 5 and is disposed between the pair of door guide shoes 7.

The door hanger 6 has a plurality of hanger rollers 9. The landing doors 4 are hung from the door rail 3 by mounting the plurality of hanger rollers 9 onto the door rail 3. When the landing doors 4 move along the opening direction of the landing entrance/exit 1, the hanger rollers 9 roll over the door rail 3.

A landing sill 10 which is fixed to the floor of the landing is provided on the lower part of the landing entrance/exit 1. A sill groove 11 which is open to the upper side is formed in the landing sill 10 along the direction of movement of the landing doors 4 (in other words, the opening direction of the landing entrance/exit 1). The landing entrance/exit device of the elevator includes the hanger case 2, the door rail 3, the landing doors 4 and the landing sill 10.

The door guide shoes 7 and detachment prevention member 8 are inserted into the sill groove 11. Each landing door 4 is moved along the opening direction of the landing entrance/exit 1, while the door guide shoes 7 and the detachment prevention member 8 remain inserted in the sill groove 11.

The car (not illustrated) inside the elevator shaft is provided with a car entrance/exit (not illustrated) which is opened and closed by the pair of car doors. The pair of car doors are moved in mutually opposite directions along the opening direction (width direction) of the car entrance/exit, by the drive power of a door drive device (not illustrated) which is provided in the car. The car entrance/exit is opened and closed by the car doors moving in mutually opposite directions.

A car sill fixed to the floor of the car is provided in the lower part of the car entrance/exit. A sill groove which is open to the upper side is formed in the car sill along the direction of movement of the car doors (in other words, the opening direction of the car entrance/exit). Each car door has a door panel, a door hanger fixed to the upper part of the door panel, and door guide shoes which are provided in the lower part of the door panel and are inserted into the sill groove in the car sill. Each of the car doors is moved along the opening direction of the car entrance/exit, while the door guide shoes remain inserted in the sill groove of the car sill.

The car entrance/exit faces the landing entrance/exit 1 when the car stops at any one of the floors. When the car stops and stays at any of the floors, the landing entrance/exit 1 and the car entrance/exit open and close simultaneously, by means of the car doors moving while being coupled with the landing doors.

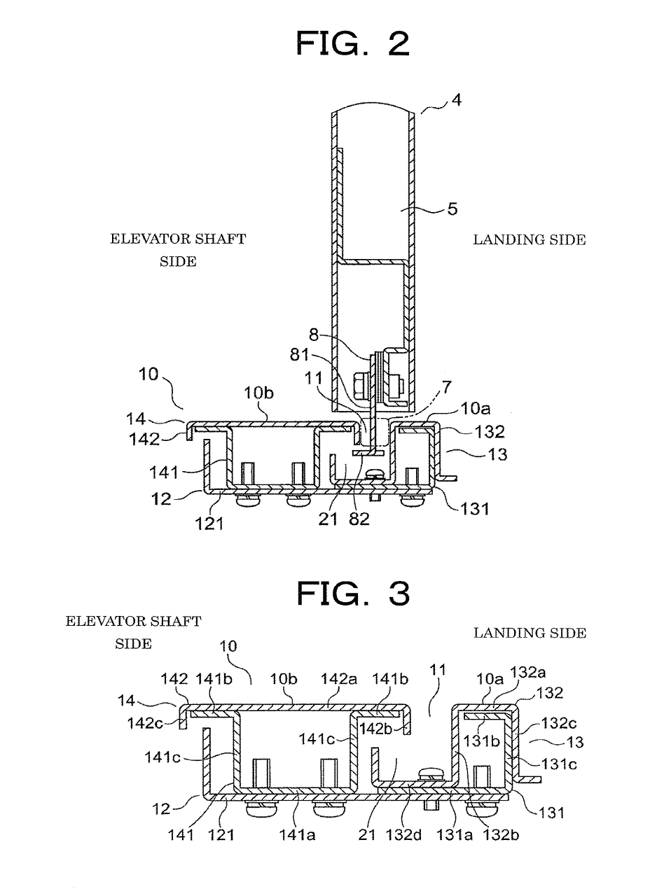

FIG. 2 is a cross-sectional diagram along line II-II in FIG. 1. Furthermore, FIG. 3 is an exploded cross-sectional diagram showing the landing sill 10 in FIG. 2. The upper surface of the landing sill 10 is divided into one upper surface 10a and another upper surface 10b which are mutually adjacent on either side of the sill groove 11. In other words, the one and other upper surfaces 10a, 10b are formed on both sides of the landing sill 10 in the width direction of the sill groove 11. In this example, one upper surface 10a is formed on the landing side as viewed from the sill groove 11, and the other upper surface 10b is formed on the elevator shaft side as viewed from the sill groove 11.

The landing sill 10 has a base plate 12, which is a foundation fixed to the floor of the landing, and a first sill member 13 and a second sill member 14, which are provided respectively on the base plate 12. The cross-sectional shapes of the base plate 12, and the first sill member 13 and the second sill member 14, are the same shape at any position of the landing sill 10 in the opening direction of the landing entrance/exit 1 (the lengthwise direction of the landing sill 10).

The base plate 12 has a horizontal plate section 121 which is disposed horizontally. The first sill member 13 and the second sill member 14 are disposed apart from each other in the width direction of the sill groove 11 on the upper surface of the horizontal plate section 121. In this example, the majority of the second sill member 14 is disposed on the elevator shaft side of the first sill member 13.

The first sill member 13 has a first support member 131 which is fixed to the upper surface of the horizontal plate section 121 and a first surface member 132 which is fixed to the first support member 131. The first support member 131, the first surface member 132 and the base plate 12 are mutually separate members.

The first support member 131 has a first overlap plate section 131a which overlaps with the upper surface of the horizontal plate section 121, a first receiving plate section 131b which is disposed above the first overlap plate section 131a, and a first vertical plate section 131c which connects the first overlap plate section 131a and the first receiving plate section 131b. Consequently, in this example, the cross-sectional shape of the first support member 131 is substantially a C shape of which the open portion faces the second sill member 14. Furthermore, in this example, the width dimension of the first overlap plate section 131a is greater than the width dimension of the first receiving plate section 131b. Moreover, in this example, the first support member 131 is formed by bending a single metal plate. The first support member 131 is fixed to the base plate 12, by means of the first overlap plate section 131a being coupled to the horizontal plate section 121 by coupling pieces (screws or bolts, etc., for example). The first support member 131 may be fixed to the base plate 12 by bonding the first overlap plate section 131a to the horizontal plate section 121 by welding.

The first surface member 132 has one upper plate section 132a which overlaps with the first receiving plate section 131b and forms one upper surface 10a of the landing sill 10 (the upper surface on the landing side in this example), a bottom plate section 132d which is positioned below the upper plate section 132a and forms a bottom surface of the sill groove 11, one side plate section 132b which connects the upper plate section 132a and the bottom plate section 132d and forms one side surface of the sill groove 11 (the side surface on the landing side in this example), and one outer plate section 132c which projects downwards from the upper plate section 132a to the outer side furthest from the first support member 131 as viewed from the sill groove 11 (to the landing side in this example) and which overlaps with the first vertical plate section 131c. Consequently, the first surface member 132 covers the first support member 131.

In this example, the first surface member 132 is formed by bending a single metal plate. Furthermore, in this example, stainless steel or a copper alloy (for example, brass, etc.) which has excellent aesthetic properties and is difficult to subject to an extrusion process or drawing process (in other words, a material with a high melting point) is chosen as the material for configuring the first surface member 132. Moreover, in this example, the upper plate section 132a and the outer plate section 132c are bonded to the first support member 131 by adhesive, and the first surface member 132 is fixed to the first support member 131 due to the outer plate section 132c being coupled to the first vertical plate section 131c by a coupling piece (for examples, a screw or bolt, etc.).

The bottom plate section 132d overlaps with the first overlap plate section 131a. In other words, the first overlap plate section 131a and the bottom plate section 132d successively overlap with the horizontal plate section 121. The bottom plate section 132d and the first overlap plate section 131a are coupled jointly to the horizontal plate section 121 by a coupling piece (for example, a screw or bolt, etc.).

The second sill member 14 has a second support member 141 which is fixed to the upper surface of the horizontal plate section 121 and a second surface member 142 which is fixed to the second support member 141. The second support member 141, the second surface member 142 and the base plate 12 are mutually separate members.

The second support member 141 has a second overlap plate section 141a which overlaps with the upper surface of the horizontal plate section 121, a pair of second receiving plate sections 141b which are disposed above the second overlap plate section 141a, and a pair of second vertical plate sections 141c which connect the second receiving plate sections 141b respectively with the second overlap plate section 141a. The pair of second receiving plate sections 141b are disposed apart from each other in the width direction of the second sill member 14. The pair of second vertical plate sections 141c are provided in standing fashion on both end portions of the second overlap plate section 141a in the width direction thereof. Consequently, in this example, the cross-sectional shape of the second support member 141 is substantially a U shape of which the open portion faces upwards. Furthermore, in this example, the second support member 141 is formed by bending a single metal plate. The second support member 141 is fixed to the base plate 12, by means of the second overlap plate section 141a being coupled to the horizontal plate section 121 by coupling pieces (screws or bolts, etc., for example). The second support member 141 may be fixed to the base plate 12 by bonding the second overlap plate section 141a to the horizontal plate section 121 by welding.

The second surface member 142 has another upper plate section 142a which overlaps above each of the second receiving plate sections 141b and forms another upper surface 10b of the landing sill 10 (the upper surface on the elevator shaft side in this example), another side plate section 142b which projects downwards from the upper plate section 142a and forms another side surface of the sill groove 11 (the side surface on the elevator shaft side in this example), and another outer plate section 142c which projects downwards from the upper plate section 142a on the outer side furthest from the second support member 141 as viewed from the sill groove 11 (on the elevator shaft side in this example). Consequently, the second surface member 142 covers the second support member 141.

In this example, the second surface member 142 is formed by bending a single metal plate. Furthermore, in this example, stainless steel or a copper alloy (for example, brass, etc.) which has excellent aesthetic properties and is difficult to subject to an extrusion process or drawing process (in other words, a material with a high melting point) is chosen as the material for configuring the second surface member 142. In this example, the first and second surface members 132, 142 are made from the same material. Moreover, in this example, the second surface member 142 is fixed to the second support member 141 by means of the upper plate section 142a being bonded and coupled to the second receiving plate section 141b by adhesive and coupling pieces (for example, screws or bolts, etc.).

The side plate section 142b of the second surface member 142 is disposed at a position separated to the upper side from the bottom plate section 132d of the first surface member 132. Consequently, a pocket 21, which is a space, is formed along the sill groove 11 between the side plate section 142b and the bottom plate section 132d.

As shown in FIG. 2, the detachment prevention member 8 has an installation plate 81 which is fixed to the lower part of the door panel 5 by coupling pieces (for example, a bolt and nut, etc.) and is inserted into the sill groove 11 from the door panel 5, and a coupling section 82 which is provided on the lower end portion of the installation plate 81 and is inserted into the pocket 21 from inside the sill groove 11. The detachment prevention member 8 is moved together with the door panel 5, while the coupling section 82 remains inserted in the pocket 21.

The coupling section 82 is disposed horizontally. Furthermore, the dimension of the coupling section 82 in the width direction of the sill groove 11 is greater than the width dimension of the sill groove 11 (the dimension between the one and other side surface of the sill groove 11). Upward displacement of the landing door 4 with respect to the landing sill 10 is prevented by means of the coupling section 82 coupling with the side plate section 142b. Consequently, the door guide shoes 7 and the detachment prevention member 8 are prevented from leaving the sill groove 11.

In the landing sill 10 for an elevator of this kind, the first surface member 132 which forms the one upper surface 10a, the one side surface of the sill groove 11 and the bottom surface of the sill groove 11 is configured as a separate member from the first support member 131, the second surface member 142 which forms the other upper surface 10b and the other side surface of the sill groove 11 is configured as a separate member from the second support member 141, and a pocket (space) 21 into which the detachment prevention member 8 fixed to the door panel 5 is inserted is formed between the side plate section 142b of the second surface member 142 and the bottom plate section 132d of the first surface member 132, and therefore it is possible to prevent the landing door 4 from leaving the sill groove 11, due to the coupling between the detachment prevention member 8 and the side plate section 142b. Furthermore, since the first and second surface members 132, 142 can be manufactured separately from the first and second support members 131, 141, then it is possible to simplify the respective shapes of the first and second surface members 132, 142 and the first and second support members 131, 141. Consequently, even if at least one of the first and second support members 131, 141 and the first and second surface members 132, 142 is made from a material that is difficult to process, it is still possible to make the manufacture of the landing sill 10 easier. In particular, for the first and second surface members 132, 142, it is possible to increase the range of selection of materials having excellent aesthetic properties for the landing sill 10, for example.

Furthermore, since the first and second surface members 132, 142 are formed by bending a plate, then the manufacture of the landing sill 10 can be made even easier.

Moreover, since the material constituting the first and second surface members 132, 142 is stainless steel or copper alloy, which has excellent aesthetic properties, then the aesthetic properties of the landing sill 10 can be improved.

In the example described above, the bottom plate section 132d of the first surface member 132 is overlapped with the overlap plate section 131a of the first support member 131, but the invention is not limited to this and the width dimension of the overlap plate section 131a may be shortened and the bottom plate section 132d may overlap directly with the horizontal plate section 121 of the base plate 12. In this case, the bottom plate section 132d avoids the overlap plate section 131a and is coupled to the horizontal plate section 121 by a coupling piece.

### Second Embodiment

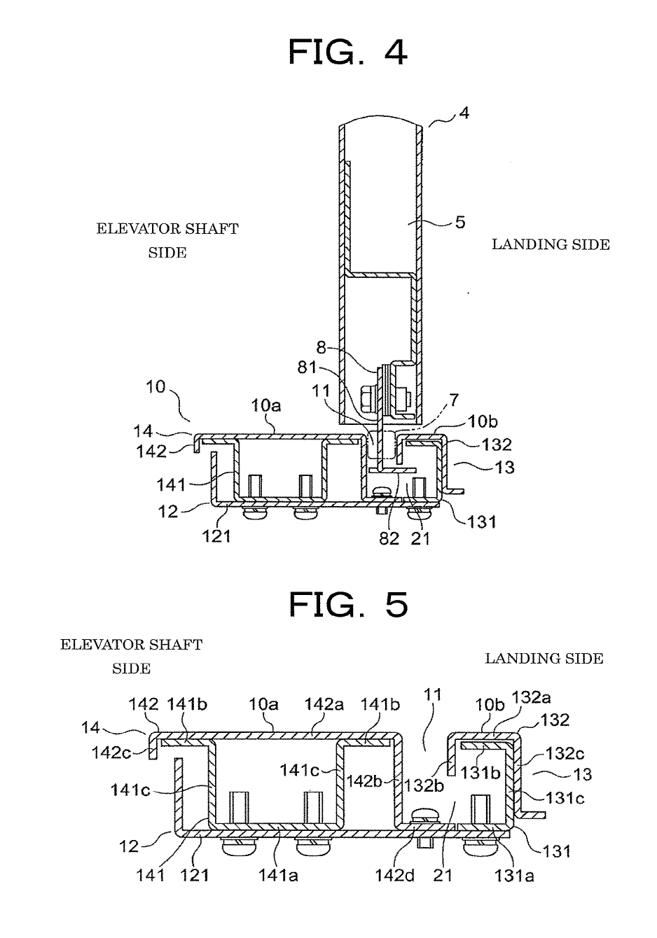

FIG. 4 is a principal cross-sectional diagram showing a landing door 4 and a landing sill 10 according to a second embodiment of this invention. Furthermore, FIG. 5 is an exploded cross-sectional diagram showing the landing sill 10 in FIG. 4. FIG. 4 and FIG. 5 are diagrams which correspond respectively to FIG. 2 and FIG. 3 in the first embodiment. One upper surface 10a and another upper surface 10b are formed on both sides of the landing sill 10 in the width direction of the sill groove 11. In this example, one upper surface 10a is formed on the elevator shaft side as viewed from the sill groove 11, and the other upper surface 10b is formed on the landing side as viewed from the sill groove 11.

The configuration of the base plate 12 and the second support member 141 is similar to the first embodiment. Furthermore, the configuration of the first support member 131 is similar to the first support member 131 of the first embodiment, except for the fact that the width dimension of the first overlap plate section 131a is substantially the same as the width dimension of the first receiving plate section 131b.

The second surface member 142 has one upper plate section 142a which overlaps with the second receiving plate sections 141b and forms one upper surface 10a of the landing sill 10 (the upper surface on the elevator shaft side in this example), a bottom plate section 142d which is positioned below the upper plate section 142a and forms a bottom surface of the sill groove 11, one side plate section 142b which connects the upper plate section 142a and the bottom plate section 142d and forms one side surface of the sill groove 11 (the side surface on the elevator shaft side in this example), and one outer plate section 142c which projects downwards from the upper plate section 142a to the outer side furthest from the second support member 141 as viewed from the sill groove 11 (to the elevator shaft side in this example). Consequently, the second surface member 142 covers the second support member 141.

The bottom plate section 142d overlaps with the horizontal plate section 121. The bottom plate section 142d is coupled to the horizontal plate section 121 by coupling pieces (for example, screws or bolts, etc.).

In this example, the second surface member 142 is formed by bending a single metal plate. Furthermore, in this example, stainless steel or copper alloy (for example, brass) is used as the material constituting the second surface member 142. Moreover, in this example, the second surface member 142 is fixed to the second support member 141 by means of the upper plate section 142a being bonded and coupled to the second receiving plate section 141b by adhesive and coupling pieces (for example, screws or bolts, etc.).

The first surface member 132 has another upper plate section 132a which overlaps above the first receiving plate section 131b and forms another upper surface 10b of the landing sill 10 (the upper surface on the landing side in this example), another side plate section 132b which projects downwards from the upper plate section 132a and forms another side surface of the sill groove 11 (the side surface on the landing side in this example), and another outer plate section 132c which projects downwards from the upper plate section 132a on the outer side furthest from the first support member 131 as viewed from the sill groove 11 (on the landing side in this example) and overlaps with the first vertical plate section 131c. Consequently, the first surface member 132 covers the first support member 131.

In this example, the first surface member 132 is formed by bending a single metal plate. Furthermore, in this example, stainless steel or copper alloy (for example, brass) is used as the material constituting the first surface member 132. In this example, the first and second surface members 132, 142 are made from the same material. Moreover, in this example, the upper plate section 132a and the outer plate section 132c are bonded to the first support member 131 by adhesive, and the first surface member 132 is fixed to the first support member 131 by coupling the outer plate section 132c to the first vertical plate section 131c by coupling pieces (for examples, screws or bolts, etc.).

The side plate section 132b of the first surface member 132 is disposed at a position separated to the upper side from the bottom plate section 142d of the second surface member 142. Consequently, a pocket 21, which is a space, is formed along the sill groove 11 between the side plate section 132b and the bottom plate section 142d.

As shown in FIG. 4, the configuration of the detachment prevention member 8 is similar to the first embodiment. Consequently, the dimension of the coupling section 82 in the width direction of the sill groove 11 is greater than the width dimension of the sill groove 11. Upward displacement of the landing door 4 with respect to the landing sill 10 is prevented by means of the coupling section 82 coupling with the side plate section 132b of the first surface member 132. Consequently, the door guide shoes 7 and the detachment prevention member 8 are prevented from leaving the sill groove 11. The remaining configuration is similar to the first embodiment.

Even though the one upper surface 10a of the landing sill 10, the one side surface of the sill groove 11 and the bottom surface of the sill groove 11 are formed by the second surface member 142, and the other upper surface 10b of the landing sill 10 and the other side surface of the sill groove 11 are formed by the first surface member 132, in this way, it is possible to form a pocket (space) 21 into which the detachment prevention member 8 fixed to the door panel 5 is inserted, between the side plate section 132b of the first surface member 132 and the bottom plate section 142d of the second surface member 142, and the landing door 4 can be prevented from leaving the sill groove 11. Furthermore, since the respective shapes of the first and second surface members 132, 142, and the first and second support members 131, 141 can be simplified, then it is possible to make the manufacture of the landing sill 10 easier, even if any of the first and second support members 131, 141 and the first and second surface members 132, 142 are made from a material that is difficult to process. In particular, for the first and second surface members 132, 142, it is possible to increase the range of selection of materials having excellent aesthetic properties for the landing sill 10, for example.

In the embodiments, the material constituting the first and second surface members 132, 142 is stainless steel or copper alloy, but the material is not limited to this. Furthermore, the materials constituting the first and second surface members 132, 142 may be mutually different.

Moreover, in the embodiments, the first and second surface members 132, 142 are formed by bending a plate, but the invention is not limited to this. For example, the first and second surface members 132, 142 may be formed by bonding a plurality of plates by welding, or the like.

Moreover, in the embodiments, one sill groove 11 is provided in the landing sill 10, but it is also possible to provide a plurality of sill grooves in the landing sill 10. Even if this configuration is adopted, the one side surface, the other side surface and the bottom surface of the sill grooves can be formed by a combination of first and second surface members.

Furthermore, in the embodiments, the invention is applied to a landing sill 10, but the invention may also be applied to the car sill. In this case, a detachment prevention member which is inserted into a pocket (space) formed in a sill groove in the car sill is fixed to the lower part of the door panel of the car door.

1. A sill for an elevator, one upper surface and another upper surface being formed in the sill on both sides of a sill groove in a width direction thereof,
wherein the sill comprises: a foundation; and
first and second sill members which are provided respectively on the foundation; and
the first sill member has a first support member fixed to the foundation, and a first surface member, which is a separate member from the first support member and is fixed to the first support member;
the second sill member has a second support member fixed to the foundation, and a second surface member, which is a separate member from the second support member and is fixed to the second support member;
of the first and second surface members,
one has one upper plate section forming the one upper surface, a bottom plate section forming a bottom surface of the sill groove, and one side plate section which connects the one upper plate section and the bottom plate section and forms one side surface of the sill groove; and
the other has another upper plate section forming the other upper surface, and another side plate section which projects downwards from the other upper plate section and forms another side surface of the sill groove; and
a space into which a detachment prevention member provided on the lower part of a door panel is inserted is formed between the other side plate section and the bottom plate section.

2. The sill for an elevator according to claim 1,
wherein the first and second surface members are formed by bending a plate.

3. The sill for an elevator according to claim 1,
wherein the material constituting the first and second surface members is stainless steel or copper alloy.

4. The sill for an elevator according to claim 2,
wherein the material constituting the first and second surface members is stainless steel or copper alloy.
